(19) United States
(12) Patent Application Publication
(10) Pub. No.: US 2024/0043597 A1
(43) Pub. Date: Feb. 8, 2024

(54) COMPOSITION AND SHEET

(71) Applicant: Resonac Corporation, Tokyo (JP)

(72) Inventors: Tomoko HIGASHIUCHI, Tokyo (JP); Hiroshi YOKOTA, Tokyo (JP); Naoki FURUKAWA, Tokyo (JP); Nozomi MATSUBARA, Tokyo (JP)

(21) Appl. No.: 18/258,467

(22) PCT Filed: Dec. 20, 2021
(86) PCT No.: PCT/JP2021/047085

§ 371 Date: Jun. 20, 2023

(30) Foreign Application Priority Data
Dec. 22, 2020 (JP) 2020-212314

(51) Int. Cl. C08F 265/08; C08J 5/18; C08L 55/02

(52) U.S. Cl. CPC C08F 265/08; C08J 5/18; C08L 55/02; C08F 222/1063

(57) ABSTRACT

A composition containing first hollow particles being thermally expandable hollow particles; second hollow particles being hollow particles other than the first hollow particles; and a polymerizable compound.

### TECHNICAL FIELD

The present invention relates to a composition and a sheet.

### BACKGROUND ART

Non-volatile memories, which feature low power consumption and high-speed read-write, are attracting attention as next-generation memory. For example, phase change memory (PCM), magnetoresistive memory (MRAM), and resistance change memory (ReRAM) are known. Non-volatile memories are vulnerable to heat, and quality maintenance when exposed to a high-temperature environment in a reflow step during mounting has become a problem.

In regard to this problem, for example, in Patent Literature 1, a non-volatile semiconductor memory device including an MRAM chip and an envelope that covers a portion or the entirety of the MRAM chip and has a thermal insulation region preventing thermal fluctuation in the magnetization of the storage layer, is disclosed.

### CITATION LIST

### Patent Literature

Patent Literature 1: Japanese Unexamined Patent Publication No. 2014-36192

### SUMMARY OF INVENTION

### Technical Problem

However, since the non-volatile semiconductor memory device disclosed in Patent Literature 1 includes a thermal insulation region as one of constituent elements, the device includes the thermal insulation region even after a reflow step. However, it is not preferable that a thermal insulation material remains in a device even after a reflow step from the viewpoints of miniaturization of devices, improvement in the degree of freedom in design, and the like. Therefore, there is a need for a thermal insulation material that can be easily removed after a reflow step.

Accordingly, an object of the present invention is to provide a composition and a sheet suitable for a thermal insulation material that can suitably adhere to a device during a reflow step and can be easily removed from the device after the reflow step.

### Solution to Problem

The present inventors conducted a thorough investigation, and as a result, they found that using thermally expandable hollow particles and hollow particles other than the thermally expandable hollow particles in combination makes a composition and a sheet appropriate for a thermal insulation material that can suitably adhere to a device during a reflow step and can be easily removed from the device after the reflow step. According to some aspects, the present invention provides the following [1] to [10].
[1] A composition containing first hollow particles being thermally expandable hollow particles; second hollow particles being hollow particles other than the first hollow particles; and a polymerizable compound.
[2] The composition according to [1], wherein the first hollow particles have an expansion initiation temperature of 70° C. or higher.
[3] The composition according to [1] or [2], wherein the first hollow particles have an expansion initiation temperature of 260° C. or lower.
[4] The composition according to any one of [1] to [3], wherein the first hollow particles have a maximum expansion temperature of 100° C. or higher.
[5] The composition according to any one of [1] to [4], wherein the first hollow particles have a maximum expansion temperature of 290° C. or lower.
[6] A sheet containing first hollow particles being thermally expandable hollow particles; second hollow particles being hollow particles other than the first hollow particles; and a matrix polymer.
[7] The composition according to [6], wherein the first hollow particles have an expansion initiation temperature of 70° C. or higher.
[8] The composition according to [6] or [7], wherein the first hollow particles have an expansion initiation temperature of 260° C. or lower.
[9] The composition according to any one of [6] to [8], wherein the first hollow particles have a maximum expansion temperature of 100° C. or higher.
[10] The composition according to any one of [6] to [9], wherein the first hollow particles have a maximum expansion temperature of 290° C. or lower.

### Advantageous Effects of Invention

According to the present invention, a composition and a sheet suitable for a thermal insulation material that can suitably adhere to a device during a reflow step and can be easily removed from the device after the reflow step can be provided.

### DESCRIPTION OF EMBODIMENTS

Embodiments of the present invention will be described in detail below. Incidentally, the present invention is not intended to be limited to the following embodiments.

The term “(meth)acryloyl” in the present specification means “acryloyl” and “methacryloyl” corresponding thereto, and the same also applies to similar expressions such as “(meth)acrylate” and “(meth)acryl”.

The weight average molecular weight (Mw) according to the present specification means a value measured by using gel permeation chromatography (GPC) under the following conditions and determined by using polystyrene as a standard substance.
Measuring instrument: HLC-8320GPC (product name, manufactured by Tosoh Corporation)
Analytical column: TSKgel SuperMultipore HZ-H (three pieces connected together) (product name, manufactured by Tosoh Corporation)
Guard column: TSKguardcolumn SuperMP (HZ)-H (product name, manufactured by Tosoh Corporation) Eluent: THF
Measurement temperature: 25° C.

[Composition]

A composition according to an embodiment contains first hollow particles, which are thermally expandable hollow particles; second hollow particles, which are hollow particles other than the first hollow particles; and a polymerizable compound.

(First Hollow Particles)

The first hollow particle has an outer shell and a hollow portion. The first hollow particles are hollow particles that expand by heat (thermally expandable). The thermally expandable hollow particles according to the present specification are hollow particles whose maximum volumetric expansion ratio relative to the volume at 25° C. is times or more. When the first hollow particles are used, as the first hollow particles expand due to heat in the reflow step, the adhesion area of the interface between the thermal insulation material and the semiconductor device is reduced, and the thermal insulation material can be easily removed after the reflow step.

The maximum volumetric expansion ratio of the first hollow particles is measured as the ratio between the maximum volume of the first hollow particles and the volume at 25° C. (maximum volume/volume at 25° C.) when temperature is increased at a temperature increase rate of 10° C./min by thermomechanical analysis (TMA). The maximum volumetric expansion ratio of the first hollow particles may be, for example, 20 times or more, 30 times or more, or 40 times or more and may be 120 times or less.

The outer shell of the first hollow particles is preferably composed of a thermoplastic polymer. In this case, since the outer shell is softened by heating, even when the liquid enclosed in the hollow portion is vaporized and the internal pressure increases, the hollow particles are less likely to crack, and the hollow particles expand easily. The thermoplastic polymer may be, for example, a polymer including acrylonitrile, vinylidene chloride, or the like as a monomer unit. The thickness of the outer shell may be 2 μm or more and may be 15 μm or less.

In the hollow portion of the first hollow particles, for example, a liquid is enclosed. The first hollow particles are in such a state under normal temperature and normal pressure (for example, at least at atmospheric pressure and 30° C.). This liquid is appropriately selected, for example, according to the heating temperature in the reflow step. The liquid is, for example, a liquid that is vaporized at a temperature equal to or lower than the highest heating temperature in the reflow step. The liquid may be, for example, a hydrocarbon having a boiling point (at atmospheric pressure) of 50° C. or higher, 100° C. or higher, 150° C. or higher, or 200° C. or higher. In the hollow portion of the first hollow particles, a gas may be further enclosed in addition to the above-described liquid.

Examples of the component enclosed in the hollow portion of the first hollow particles include hydrocarbons such as propane, propylene, butene, normal butane, isobutane, normal pentane, isopentane, neopentane, normal hexane, isohexane, heptane, isooctane, normal octane, isoalkanes (number of carbon atoms: 10 to 13), and petroleum ether; low-boiling point compounds such as methane halides and tetraalkylsilanes; and compounds that are gasified by thermal decomposition, such as azodicarbonamide.

The average particle size of the first hollow particles may be 5 μm or more, 10 μm or more, or 20 μm or more, and may be 50 μm or less, 40 μm or less, or 30 μm or less. The average particle size of the first hollow particles is measured by a laser diffraction and scattering method (for example, “SALD-7500nano” manufactured by SHIMADZU CORPORATION).

From the viewpoint that a composition is more suitably used as a thermal insulation material in a reflow step (generally heated up to 260° C.), the expansion initiation temperature of the first hollow particles is preferably 70° C. or higher, 100° C. or higher, 130° C. or higher, or 160° C. or higher and is preferably 260° C. or lower. The expansion initiation temperature of the first hollow particles means, in a temperature (axis of abscissa)-volume change (axis of ordinate) profile obtained when temperature is increased at a temperature increase rate of in thermomechanical analysis (TMA), the temperature at an intersection point between the tangent at a point where a volumetric change of 3 times or more/5° C. occurs and a straight line (axis of abscissa) where the volumetric change is zero (initial volume).

From the viewpoint that the composition is more suitably used as a thermal insulation material in the reflow step, the maximum expansion temperature of the first hollow particles is preferably 100° C. or higher, 150° C. or higher, 200° C. or higher, or 220° C. or higher, and is preferably 290° C. or lower, 280° C. or lower, or 270° C. or lower. The maximum expansion temperature of the first hollow particles means the temperature at which the first hollow particles exhibit the above-mentioned maximum volumetric expansion ratio.

From the viewpoint that removal of the composition after the reflow step is further facilitated, the content of the first hollow particles may be preferably 1% by mass or more, more preferably 5% by mass or more, and even more preferably 8% by mass or more, and may be 20% by mass or less or 15% by mass or less, based on the total mass of the composition.

From the viewpoint that removal of the composition after the reflow step is further facilitated, the content of the first hollow particles is preferably 1% by volume or more, more preferably 2% by volume or more, even more preferably 3% by volume or more, and particularly preferably 4% by volume or more, based on the total volume of the composition, and the content may be, for example, 10% by volume or less, 7% by volume or less, or 5% by volume or less.

(Second Hollow Particles)

The second hollow particle has an outer shell and a hollow portion. The second hollow particles are hollow particles other than the first hollow particles. That is, the second hollow particles are hollow particles whose maximum volumetric expansion ratio relative to the volume at 25° C. is less than 10 times. By using the second hollow particles, the thermal insulation properties of the composition are improved, and the composition can be suitably utilized as a thermal insulation material. The maximum volumetric expansion ratio of the second hollow particles is measured by the same method as that for the maximum volumetric expansion ratio of the first hollow particles.

The outer shell of the second hollow particles may be composed of a polymer or may be composed of an inorganic material. The outer shell is preferably composed of a polymer and is more preferably composed of a thermoplastic polymer. In this case, the hollow particles are less likely to crack even when pressure is applied, and the hollow particles can retain a hollow structure and can maintain thermal insulation properties. The thermoplastic polymer may be, for example, a polymer containing acrylonitrile, vinylidene chloride, or the like as a monomer unit. The inorganic material may be, for example, inorganic glass such as borosilicate glass (sodium borosilicate glass or the like), aluminosilicate glass, or glass obtained by compositizing those. The thickness of the outer shell may be 0.005 μm or more and may be 15 μm or less.

In the hollow portion of the second hollow particles, for example, a gas is enclosed. The second hollow particles are in such a state under normal temperature and normal pressure (for example, at least at atmospheric pressure and 30° C.). In the hollow portion of the second hollow particles, a liquid may be further enclosed in addition to the gas.

Examples of the component enclosed in the hollow portion of the second hollow particles include hydrocarbons such as propane, propylene, butene, normal butane, isobutane, normal pentane, isopentane, neopentane, normal hexane, isohexane, heptane, isooctane, normal octane, isoalkanes (number of carbon atoms: 10 to 13), and petroleum ether; low-boiling point compounds such as methane halides and tetraalkylsilanes; and decomposition products of compounds that are gasified by thermal decomposition, such as azodicarbonamide. Furthermore, the component enclosed in the hollow portion of the second hollow particles may be air.

From the viewpoint of enhancing the thermal insulation properties, the average particle size of the second hollow particles is preferably 150 μm or less, more preferably 120 μm or less, and even more preferably 100 μm or less, and the average particle size may be, for example, 5 μm or more, 10 μm or more, 20 μm or more, or 30 μm or more. The average particle size of the second hollow particles is measured by a laser diffraction and scattering method (for example, “SALD-7500nano” manufactured by SHIMADZU CORPORATION).

The density of the second hollow particles may be 500 kg/m³ or less, 300 kg/m³ or less, 100 kg/m³ or less, 50 kg/m³ or less, or 40 kg/m³ or less, and may be 10 kg/m³ or more or 20 kg/m³ or more. The density of the second hollow particles according to the present specification means a density measured by a tapped density method. That is, the density is a density determined by introducing the second hollow particles (about 5 g) into a 10-mL graduated cylinder, tapping the graduated cylinder fifty times, and using the volume when the topmost surface is stabilized as the stable volume and the following formula:

Density=Initial input amount (kg)/stable volume (m³)

From the viewpoint of enhancing the thermal insulation properties of the composition, the content of the second hollow particles is preferably 1% by mass or more, more preferably 3% by mass or more, and even more preferably 5% by mass or more, based on the total mass of the composition, and the content may be, for example, 20% by mass or less.

From the viewpoint of enhancing the thermal insulation properties of the composition, the content of the second hollow particles is preferably 50% by volume or more, and more preferably 60% by volume or more, based on the total volume of the composition, and the content may be, for example, 95% by volume or less.

The total content of the hollow particles (content including the first hollow particles and the second hollow particles) may be, for example, 5% by mass or more, 10% by mass or more, or 15% by mass or more, based on the total mass of the composition, and the total content may be 40% by mass or less, 30% by mass or less, or 20% by mass or less.

The total content of the hollow particles (content including the first hollow particles and the second hollow particles) may be, for example, 50% by volume or more, 60% by volume or more, or 70% by volume or more, based on the total volume of the composition, and the total content may be 95% by volume or less.

(Polymerizable Compound)

The polymerizable compound is not particularly limited, and may contain, for example, a compound represented by the following Formula (1).

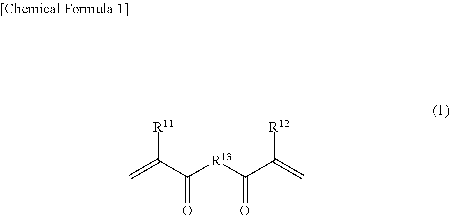

In the Formula (1), R¹¹ and R¹² each independently represents a hydrogen atom or a methyl group, and R¹³ represents a divalent group having a polyoxyalkylene chain.

When the polymerizable compound is a compound represented by the above Formula (1), a cured product of the composition has low elasticity and excellent elongation and can enhance the conformability to the shape of an adherend.

According to an embodiment, one of R¹¹ and R¹² may be a hydrogen atom while the other may be a methyl group; according to another embodiment, both R¹¹ and R¹² may be hydrogen atoms; and according to another embodiment, both R¹¹ and R¹² may be methyl groups.

According to an embodiment, the polyoxyalkylene chain contains a structural unit represented by the following Formula (2). As a result, the strength of the cured product can be increased while suppressing an excessive increase in the viscosity of the composition.

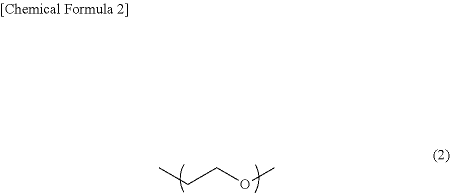

In this case, R¹³ may be a divalent group having a polyoxyethylene chain, and the compound represented by the Formula (1) is preferably a compound represented by the following Formula (1-2) (polyethylene glycol di(meth)acrylate).

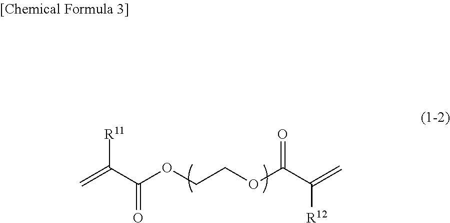

In the Formula (1-2), R¹¹ and R¹² have the same meanings as R¹¹ and R¹² in the Formula (1), respectively, and in is an integer of 2 or greater.

According to another embodiment, the polyoxyalkylene chain contains a structural unit represented by the following Formula (3). As a result, handling of the composition can be facilitated.

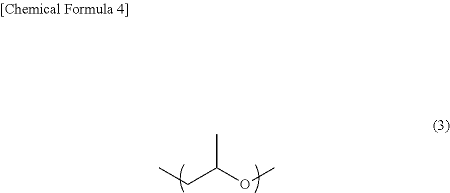

In this case, R¹³ may be a divalent group having a polyoxypropylene chain, and the compound represented by the Formula (1) is preferably a compound represented by the following Formula (1-3) (polypropylene glycol di(meth)acrylate).

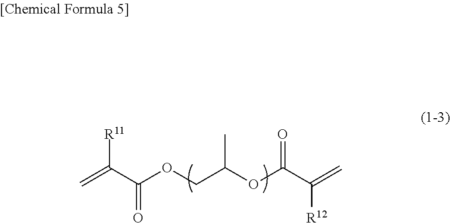

In the Formula (1-3), R¹¹ and R¹² have the same meanings as R¹¹ and R¹² in the Formula (1), respectively, and n is an integer of 2 or greater.

According to another embodiment, from the viewpoint of making it easier to achieve both the strength of a cured product of the compound represented by the Formula (1) and the handleability of the composition, the polyoxyalkylene chain is preferably a copolymer chain containing the above-mentioned structural unit represented by the Formula (2) and the above-mentioned structural unit represented by the Formula (3). The copolymer chain may be any of an alternating copolymer chain, a block copolymer chain, or a random copolymer chain. From the viewpoint that the crystallinity of the compound represented by the Formula (1) can be further lowered, and handling of the composition can be further facilitated, the copolymer chain is preferably a random copolymer chain.

In each of the above-mentioned embodiments, the polyoxyalkylene chain may have an oxyalkylene group having 4 or 5 carbon atoms, such as an oxytetramethylene group, an oxybutylene group, or an oxypentylene group, as a structural unit in addition to the structural unit represented by the Formula (2) and the structural unit represented by the Formula (3).

R¹³ may also be a divalent group further having an additional organic group, in addition to the above-mentioned polyoxyalkylene chain. The additional organic group may be a chain-shaped group other than a polyoxyalkylene chain, and examples contain a methylene chain (a chain having —CH₂— as a structural unit), a polyester chain (a chain having —COO— in a structural unit), and a polyurethane chain (a chain containing —OCON— in a structural unit).

For example, the compound represented by the Formula (1) may be a compound represented by the following Formula (1-4).

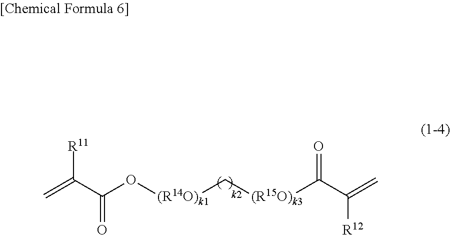

In the Formula (1-4), R¹¹ and R¹² have the same meanings as R¹¹ and R¹² in the Formula (1), respectively; R¹⁴ and R¹⁵ each independently represent an alkylene group having 2 to 5 carbon atoms; and k1, k2, and k3 each independently represent an integer of 2 or greater. k2 may be, for example, an integer of 16 or less.

A plurality of R¹⁴ present therein may be identical to each other or may be different from each other, and a plurality of R¹⁵ present therein may be identical to each other or may be different from each other. A plurality of R¹⁴ and a plurality of R¹⁵ present therein each preferably contains an ethylene group and a propylene group. That is, each of the polyoxyalkylene chain represented by (R¹⁴O)ₖ₁ and the polyoxyalkylene chain represented by (R¹⁵O)ₖ₃ is preferably a copolymer chain containing an oxyethylene group (the above-described structural unit represented by the Formula (2)) and an oxypropylene group (the above-described structural unit represented by the Formula (3)).

In each of the above-mentioned embodiments, the number of oxyalkylene groups in the polyoxyalkylene chain is preferably 100 or greater. When the number of oxyalkylene groups in the polyoxyalkylene chain is 100 or greater, as the main chain of the compound represented by the Formula (1) is lengthened, the elongation of the cured product is more excellent, and the strength of the cured product can also be increased. The number of oxyalkylene groups corresponds to each of in in the Formula (1-2), n in the Formula (1-3), and k1 and k3 in the Formula (1-4).

The number of oxyalkylene groups in the polyoxyalkylene chain is more preferably 130 or greater, 180 or greater, 200 or greater, 220 or greater, 250 or greater, 270 or greater, 300 or greater, or 320 or greater. The number of oxyalkylene groups in the polyoxyalkylene chain may be 600 or less, 570 or less, or 530 or less.

From the viewpoint that the cured product has lower elasticity and more excellent elongation, the weight average molecular weight of the compound represented by the Formula (1) is preferably 5000 or more, 6000 or more, 7000 or more, 8000 or more, 9000 or more, 10000 or more, 11000 or more, 12000 or more, 13000 or more, 14000 or more, or 15000 or more. From the viewpoint of facilitating adjustment of the viscosity of the composition, the weight average molecular weight of the compound represented by the Formula (1) is preferably 100000 or less, 80000 or less, 60000 or less, 34000 or less, 31000 or less, or 28000 or less.

The compound represented by the Formula (1) may be liquid at 25° C. In this case, from the viewpoint of facilitating application on a coating surface and from the viewpoint of increasing the adhesiveness of the cured product to the coating surface, the viscosity at 25° C. of the compound represented by the Formula (1) is preferably 1000 Pa·s or less, 800 Pa·s or less, 600 Pa·s or less, 500 Pa·s or less, 350 Pa·s or less, 300 Pa·s or less, or 200 Pa·s or less. The viscosity at 25° C. of the compound represented by the Formula (1) may be 0.1 Pa·s or more, 0.2 Pa·s or more, 0.3 Pa·s or more, 1 Pa·s or more, 2 Pa·s or more, or 3 Pa·s or more.

The compound represented by the Formula (1) may be solid at 25° C. In this case, from the viewpoint of further improving the handleability of the composition, the compound represented by the Formula (1) is preferably liquid at 50° C. Furthermore, in this case, from the viewpoint of further improving the handleability of the composition, the viscosity at 50° C. of the compound represented by the Formula (1) is preferably 100 Pa·s or less, more preferably 50 Pa·s or less, even more preferably 30 Pa·s or less, and particularly preferably 20 Pa·s or less. The viscosity at 50° C. of the compound represented by the Formula (1) may be 0.1 Pa·s or more, 0.2 Pa·s or more, or 0.3 Pa·s or more.

The viscosity means a value measured based on JIS Z 8803 and specifically means a value measured with an E-type viscometer (for example, PE-80L manufactured by Told Sangyo Co., Ltd.). Incidentally, calibration of the viscometer can be carried out based on JIS Z 8809-JS 14000. The viscosity of the compound represented by the Formula (1) can be adjusted by adjusting the weight average molecular weight of the compound.

From the viewpoint that the cured product has lower elasticity and more excellent elongation, the content of the compound represented by the Formula (1) is preferably 10% by mass or more, 20% by mass or more, 30% by mass or more, or 40% by mass or more, based on the total amount of the composition. The content of the compound represented by the Formula (1) may be 90% by mass or less, 80% by mass or less, 70% by mass or less, 60% by mass or less, or 50% by mass or less, based on the total amount of the composition.

The composition may contain only the compound represented by the Formula (1) as a polymerizable compound. The composition may further contain an additional polymerizable compound (the details will be described below) other than the compound represented by the Formula (1). In this case, from the viewpoint that the cured product has lower elasticity and more excellent elongation, the content of the compound represented by the Formula (1) is preferably 20 parts by mass or more, 30 parts by mass or more, or 40 parts by mass or more, with respect to 100 parts by mass of the sum of the compound represented by the Formula (1) and the additional polymerizable compound (hereinafter, referred to as “total content of the polymerizable components”). The content of the compound represented by the Formula (1) may be 80 parts by mass or less, 70 parts by mass or less, or 60 parts by mass or less, with respect to 100 parts by mass of the total content of the polymerizable components.

The polymerizable compound may contain a polymerizable compound other than the compound represented by the Formula (1).

The additional polymerizable compound may be, for example, a compound having one (meth)acryloyl group. This compound may be, for example, an alkyl (meth)acrylate. The additional polymerizable compound may also be a compound having, in addition to the one (meth)acryloyl group, an aromatic hydrocarbon group, a group containing a polyoxyalkylene chain, a group containing a heterocyclic ring, an alkoxy group, a phenoxy group, a group containing a silane group, a group containing a siloxane bond, a halogen atom, a hydroxyl group, a carboxyl group, an amino group, or an epoxy group. Particularly, when the composition contains an alkyl (meth)acrylate, the viscosity of the composition can be adjusted. Furthermore, when the composition contains a compound having a hydroxyl group, a carboxyl group, an amino group, or an epoxy group in addition to a (meth)acryloyl group, the adhesiveness of the composition and the thermal insulation material to an object can be further improved.

The alkyl group (alkyl group moiety other than the (meth)acryloyl group) in an alkyl (meth)acrylate may be linear, branched, or alicyclic. The number of carbon atoms of the alkyl group may be, for example, 1 to 30. The number of carbon atoms of the alkyl group may be 1 to 11, 1 to 8, 1 to 6, or 1 to 4 and may be 12 to 30, 12 to 28, 12 to 24, 12 to 22, 12 to 18, or 12 to 14.

Examples of the alkyl (meth)acrylate having a linear alkyl group include an alkyl (meth)acrylate having a linear alkyl group having 1 to 11 carbon atoms, such as methyl (meth)acrylate, ethyl (meth)acrylate, propyl (meth)acrylate, butyl (meth)acrylate, pentyl (meth)acrylate, n-hexyl (meth)acrylate, n-heptyl (meth)acrylate, octyl (meth)acrylate, nonyl (meth)acrylate, decyl (meth)acrylate, or undecyl (meth)acrylate; and an alkyl (meth)acrylate having a linear alkyl group having 12 to 30 carbon atoms, such as dodecyl (meth)acrylate (lauryl (meth)acrylate), tetradecyl (meth)acrylate, hexadecyl (meth)acrylate (cetyl (meth)acrylate), octadecyl (meth)acrylate (stearyl (meth)acrylate), docosyl (meth)acrylate (behenyl (meth)acrylate), tetracosyl (meth)acrylate, hexacosyl (meth)acrylate, or octacosyl (meth)acrylate.

Examples of the alkyl (meth)acrylate having a branched alkyl group include an alkyl (meth)acrylate having a branched alkyl group having 1 to 11 carbon atoms, such as s-butyl (meth)acrylate, t-butyl (meth)acrylate, isobutyl (meth)acrylate, isopentyl (meth)acrylate, isoamyl (meth)acrylate, isooctyl (meth)acrylate, 2-ethylhexyl (meth)acrylate, isononyl (meth)acrylate, or isodecyl (meth)acrylate; and an alkyl (meth)acrylate having a branched alkyl group having 12 to 30 carbon atoms, such as isomyristyl (meth)acrylate, 2-propylheptyl (meth)acrylate, isoundecyl (meth)acrylate, isododecyl (meth)acrylate, isotridecyl (meth)acrylate, isopentadecyl (meth)acrylate, isohexadecyl (meth)acrylate, isoheptadecyl (meth)acrylate, isostearyl (meth)acrylate, or decyltetradecanyl (meth)acrylate.

Examples of the alkyl (meth)acrylate having an alicyclic alkyl group (cycloalkyl group) include cyclohexyl (meth)acrylate, 3,3,5-trimethylcyclohexyl (meth)acrylate, isobornyl (meth)acrylate, terpene (meth)acrylate, or dicyclopentanyl (meth)acrylate.

Examples of the compound having a (meth)acryloyl group and an aromatic hydrocarbon group include benzyl (meth)acrylate.

Examples of the compound having a (meth)acryloyl group and a group containing a polyoxyalkylene chain include polyethylene glycol (meth)acrylate, methoxy polyethylene glycol (meth)acrylate, polypropylene glycol (meth)acrylate, methoxy polypropylene glycol (meth)acrylate, polybutylene glycol (meth)acrylate, and methoxy polybutylene glycol (meth)acrylate.

Examples of the compound having a (meth)acryloyl group and a group containing a heterocyclic ring include tetrahydrofurfuryl (meth)acrylate.

Examples of the compound having a (meth)acryloyl group and an alkoxy group include 2-methoxyethyl acrylate.

Examples of the compound having a (meth)acryloyl group and a phenoxy group include phenoxyethyl (meth)acrylate.

Examples of the compound having a (meth)acryloyl group and a group containing a silane group include 3-acryloxypropyltriethoxysilane, 10-methacryloyloxydecyltrimethoxysilane, 10-acryloyloxydecyltrimethoxysilane, 10-ethacryloyloxydecyltriethoxysilane, and 10-acryloyloxydecyltriethoxysilane.

Examples of the compound having a (meth)acryloyl group and a group containing a siloxane bond include silicone (meth)acrylate.

Examples of the compound having a (meth)acryloyl group and a halogen atom include (meth)acrylates having fluorine atoms, such as trifluoromethyl (meth)acrylate, 2,2,2-trifluoroethyl (meth)acrylate, 1,1,1,3,3,3-hexafluoro-2-propyl (meth)acrylate, perfluoroethylmethyl (meth)acrylate, perfluoropropylmethyl (meth)acrylate, perfluorobutylmethyl (meth)acrylate, perfluoropentylmethyl (meth)acrylate, perfluorohexylmethyl (meth)acrylate, perfluoroheptylmethyl (meth)acrylate, perfluorooctylmethyl (meth)acrylate, perfluorononylmethyl (meth)acrylate, perfluorodecylmethyl (meth)acrylate, perfluoroundecylmethyl (meth)acrylate, perfluorododecylmethyl (meth)acrylate, perfluorotridecylmethyl (meth)acrylate, perfluorotetradecylmethyl (meth)acrylate, 2-(trifluoromethyl)ethyl (meth)acrylate, 2-(perfluoroethyl)ethyl (meth)acrylate, 2-(perfluoropropyl)ethyl (meth)acrylate, 2-(perfluorobutyl)ethyl (meth)acrylate, 2-(perfluoropentyl)ethyl (meth)acrylate, 2-(perfluorohexyl)ethyl (meth)acrylate, 2-(perfluoroheptyl)ethyl (meth)acrylate, 2-(perfluorooctyl)ethyl (meth)acrylate, 2-(perfluorononyl)ethyl (meth)acrylate, 2-(perfluorotridecyl)ethyl (meth)acrylate, and 2-(perfluorotetradecyl)ethyl (meth)acrylate.

Examples of the compound having a (meth)acryloyl group and a hydroxyl group include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; and hydroxyalkylcycloalkane (meth)acrylate s such as (4-hydroxymethylcyclohexyl)methyl (meth)acrylate.

Examples of the compound having a (meth)acryloyl group and a carboxyl group include (meth)acrylic acid, carboxyethyl (meth)acrylate, carboxypentyl (meth)acrylate, phthalic acid monohydroxyethyl acrylate (for example, “ARONIX M5400” manufactured by TOAGOSEI CO., LTD.), and 2-acryloyloxyethyl succinate (for example, “NK ESTER A-SA” manufactured by SHIN-NAKAMURA CHEMICAL Co., Ltd.).

Examples of the compound having a (meth)acryloyl group and an amino group include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate.

Examples of the compound having a (meth)acryloyl group and an epoxy group include glycidyl (meth)acrylate, glycidyl α-ethyl (meth)acrylate, glycidyl α-n-propyl (meth)acrylate, glycidyl α-n-butyl (meth)acrylate, 3,4-epoxybutyl (meth)acrylate, 4,5-epoxypentyl (meth)acrylate, 6,7-epoxyheptyl (meth)acrylate, 6,7-epoxyheptyl α-ethyl (meth)acrylate, 3-methyl-3,4-epoxybutyl (meth)acrylate, 4-methyl-4,5-epoxypentyl (meth)acrylate, 5-methyl-5,6-epoxyhexyl (meth)acrylate, β-methylglycidyl (meth)acrylate, and β-methylglycidyl α-ethyl (meth)acrylate.

The composition may contain one kind of the above-described additional polymerizable compounds, or may contain two or more kinds thereof as the polymerizable compound. The composition may or may not further contain a compound represented by the Formula (1).

The content of the additional polymerizable compound other than the compound represented by the Formula (1) may be, for example, 1% by mass or more, 5% by mass or more, 10% by mass or more, 20% by mass or more, or 30% by mass or more, and may be 60% by mass or less, 50% by mass or less, or 40% by mass or less, based on the total amount of the composition.

The content of the polymerizable compounds (total content of the compound represented by the Formula (1) and the additional polymerizable compound) may be, for example, 40% by mass or more, 50% by mass or more, 60% by mass or more, or 70% by mass or more, based on the total amount of the composition, and the content may be 95% by mass or less or 90% by mass or less.

The composition may further contain a polymerization initiator. The polymerization initiator may be, for example, a thermal polymerization initiator that generates radicals by heat, and a photopolymerization initiator that generates radicals by light. The polymerization initiator is preferably a thermal polymerization initiator.

When the composition contains a thermal polymerization initiator, a cured product of the composition can be obtained by applying heat to the composition. In this case, the composition may be a composition that is cured by heating preferably at 105° C. or higher, more preferably at 110° C. or higher, and even more preferably at 115° C. or higher, and may be a composition that is cured by heating at, for example, 200° C. or lower, 190° C. or lower, or 180° C. or lower. The heating time at the time of heating the composition may be appropriately selected according to the composition of the composition such that the composition is suitably cured.

Examples of the thermal polymerization initiator include azo compounds such as azobisisobutyronitrile, azobis-4-methoxy-2,4-dimethylvaleronitrile, azobiscyclohexanone-1-carbonitrile, and azodibenzoyl; and organic peroxides such as benzoyl peroxide, lauroyl peroxide, di-t-butyl peroxide, di-t-hexyl peroxide, di-t-butyl peroxyhexahydroterephthalate, t-butyl peroxy-2-ethylhexanoate, 1,1-t-butyl peroxy-3,3,5-trimethylcyclohexane, and t-butyl peroxyisopropyl carbonate. Regarding the thermal polymerization initiator, these may be used singly or in combination of two or more kinds thereof.

When the composition contains a photopolymerization initiator, a cured product of the composition can be obtained by, for example, irradiating the composition with light (for example, light including at least a portion of the wavelengths of 200 to 400 nm (ultraviolet light)). The conditions for light irradiation may be appropriately set according to the type of the photopolymerization initiator.

Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (for example, “IRGACURE 651” manufactured by BASF), and anisole methyl ether. Examples of the acetophenone-based photopolymerization initiator include 1-hydroxycyclohexyl phenyl ketone (for example, “IRGACURE 184” manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (for example, “IRGACURE 2959” manufactured by BASF), 2-hydroxy-2-methyl-1-phenyl-propan-1-one (for example, “IRGACURE 1173” manufactured by BASF), and methoxyacetophenone.

Examples of the α-ketol-based photopolymerization initiator include 2-methyl-2-hydroxypropiophenone and 1-[4-(2-hydroxyethyl)-phenyl]-2-hydroxy-2-methylpropan-1-one. Examples of the aromatic sulfonyl chloride-based photopolymerization initiator include 2-naphthalenesulfonyl chloride. Examples of the photoactive oxime-based photopolymerization initiator include 1-phenyl-1,1-propanedione-2-(o-ethoxycarbonyl)-oxime.

Examples of the benzoin-based photopolymerization initiator include benzoin. Examples of the benzil-based photopolymerization initiator include benzil. Examples of the benzophenone-based photopolymerization initiator include benzophenone, benzoylbenzoic acid, 3,3′-dimethyl-4-methoxybenzophenone, polyvinylbenzophenone, and α-hydroxycyclohexyl phenyl ketone. Examples of the ketal-based photopolymerization initiator include benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Examples of the acylphosphine-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-m ethylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoylbenzylbutylphosphine oxide, 2,6-dimethoxybenzoylbenzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis [bis(2,4,6-trimethylbenzoyl)phosphine oxide]decane, and tri(2-methylbenzoyl)phosphine oxide.

The above-mentioned photopolymerization initiators may be used singly or in combination of two or more kinds thereof.

From the viewpoint of suitably carrying out polymerization, the content of the polymerization initiator is preferably 0.01 parts by mass or more, more preferably 0.02 parts by mass or more, and even more preferably 0.05 parts by mass or more, with respect to 100 parts by mass of the total content of the polymerizable components. From the viewpoint that the molecular weight of the polymer in the cured product of the composition is in a suitable range, and the decomposition product is suppressed, the content of the polymerization initiator is preferably 10 parts by mass or less, more preferably 5 parts by mass or less, even more preferably 3 parts by mass or less, and particularly preferably 1 part by mass or less, with respect to 100 parts by mass of the total content of the polymerizable components.

The composition can contain a plasticizer as an additive. When the composition contains a plasticizer, the adhesiveness of the composition and the elongation of the cured product can be further enhanced. Examples of the plasticizer include butadiene rubber, isoprene rubber, silicone rubber, styrene-butadiene rubber, chloroprene rubber, nitrile rubber, butyl rubber, ethylene-propylene rubber, urethane rubber; tackifiers such as an acrylic resin, a rosin-based resin, and a terpene-based resin; and a polyalkylene glycol. The content of the plasticizer may be 0.1 parts by mass or more, 1 part by mass or more, or 3 parts by mass or more, with respect to 100 parts by mass of the total content of the polymerizable components, and the content may be 20 parts by mass or less, 15 parts by mass or less, 12 parts by mass or less, or 10 parts by mass or less.

The composition can further contain an additional additive as necessary. Examples of the additional additive include an antioxidant, a surface treatment agent (for example, a silane coupling agent), a dispersant, a curing accelerator, a colorant, a crystal nucleating agent, a thermal stabilizer, a foaming agent, a flame retardant, a damping agent, a dehydrating agent, and a flame retardant aid (for example, a metal oxide). The content of the additional additive may be 0.1% by mass or more and may be 30% by mass or less, based on the total amount of the composition.

The composition is preferably liquid at 25° C. As a result, the composition can be suitably applied on the surface of an object such as a non-volatile semiconductor memory device, and the adhesiveness to a coating surface can also be enhanced. The composition may be solid at 25° C., and in that case, it is preferable that the composition becomes liquid by heating (for example, at 50° C. or higher). The composition may be applied in a liquid state and then cured, and as a result, the composition can be prevented from causing liquid dripping and a pump-out phenomenon.

[Composition Set]

The above-mentioned composition may be in a state of a multi-liquid type composition (composition set). A composition set according to an embodiment is a composition set containing a first liquid containing an oxidizing agent and a second liquid containing a reducing agent. The first hollow particles, the second hollow particles, and the polymerizable compound are each contained in at least one of the first liquid and the second liquid. When the first liquid and the second liquid are mixed, the oxidizing agent and the reducing agent react with each other to generate free radicals, and polymerization of the polymerizable compounds proceeds. According to the composition set related to the present embodiment, a cured product of a mixture of the first liquid and the second liquid can be immediately obtained by mixing the first liquid and the second liquid. That is, according to the composition set, a cured product of the composition is obtained at a rapid speed.

With regard to the composition set, preferably, the first liquid contains an oxidizing agent, a polymerizable compound, first hollow particles, and second hollow particles, while the second liquid contains a reducing agent, a polymerizable compound, first hollow particles, and second hollow particles. More preferably, the first liquid contains an oxidizing agent, a polymerizable compound represented by the Formula (1), first hollow particles, and second hollow particles, while the second liquid contains a reducing agent, a polymerizable compound represented by the Formula (1), first hollow particles, and second hollow particles.

The content of the compound represented by the Formula (1) based on the total amount of the liquids constituting the composition set (for example, in the case of a two-liquid type composition set, the total amount of the first liquid and the second liquid) may be the same as the range of the content of the compound represented by the Formula (1) based on the total amount of the above-mentioned composition. The same also applies to the content of the hollow particles contained in the composition set.

The oxidizing agent contained in the first liquid has a role as a polymerization initiator (radical polymerization initiator). The oxidizing agent may be, for example, an organic peroxide or an azo compound. The organic peroxide may be, for example, a hydroperoxide, a peroxydicarbonate, a peroxy ester, a peroxy ketal, a dialkyl peroxide, and a diacyl peroxide. The azo compound may be AIBN (2,2′-azobisisobutyronitrile), V-65 (azobisdimethylvaleronitrile), or the like. The oxidizing agents can be used singly or in combination of two or more kinds thereof.

Examples of the hydroperoxide include diisopropylbenzene hydroperoxide and cumene hydroperoxide.

Examples of the peroxydicarbonate include di-n-propyl peroxydicarbonate, diisopropyl peroxydicarbonate, bis(4-t-butylcyclohexyl) peroxydicarbonate, di-2-ethoxymethoxy peroxydicarbonate, di(2-ethylhexylperoxy) dicarbonate, dimethoxybutyl peroxydicarbonate, and di(3-methyl-3-methoxybutylperoxy) dicarbonate.

Examples of the peroxy ester include cumyl peroxyneodecanoate, 1,1,3,3-tetramethylbutyl peroxyneodecanoate, 1-cyclohexyl-1-methylethyl peroxyneodecanoate, t-hexyl peroxyneodecanoate, t-butyl peroxypivalate, 1,1,3,3-tetramethylbutyl peroxy-2-ethylhexanonate, 2,5-dimethyl-2,5-di(2-ethylhexanoylperoxy)hexane, 1-cyclohexyl-1-methylethyl peroxy-2-ethylhexanonate, t-hexyl peroxy-2-ethylhexanonate, t-butyl peroxy-2-ethylhexanonate, t-butyl peroxyisobutyrate, 1,1-bis(t-butylperoxy)cyclohexane, t-butyl peroxy-3,5,5-trimethylhexanonate, t-butyl peroxylaurate, 2,5-dimethyl-2,5-di(m-toluoylperoxy)hexane, t-hexyl peroxybenzoate, and t-butyl peroxyacetate.

Examples of the peroxy ketal include 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)cyclododecane, and 2,2-bis(t-butylperoxy)decane.

Examples of the dialkyl peroxide include α,α′-bis(t-butylperoxy)diisopropylbenzene, dicumyl peroxide, 2,5-dimethyl-2,5-di(t-butylperoxy)hexane, and t-butylcumyl peroxide.

Examples of the diacyl peroxide include isobutyl peroxide, 2,4-dichlorobenzoyl peroxide, 3,5,5-trimethylhexanoyl peroxide, octanoyl peroxide, lauroyl peroxide, stearoyl peroxide, succinic peroxide, benzoyl peroxytoluene, and benzoyl peroxide.

From the viewpoint of storage stability, the oxidizing agent is preferably a peroxide, more preferably a hydroperoxide, and even more preferably cumene hydroperoxide.

The content of the oxidizing agent may be 0.1% by mass or more, 0.5% by mass or more, or 1% by mass or more, and may be 10% by mass or less, 5% by mass or less, or 3% by mass or less, based on the total amount of the liquids constituting the composition set.

The reducing agent contained in the second liquid may be, for example, a tertiary amine, a thiourea derivative, or a transition metal salt. Examples of the tertiary amine include triethylamine, tripropylamine, tributylamine, and N,N-dimethyl-para-toluidine. Examples of the thiourea derivative include 2-mercaptobenzimidazole, methylthiourea, dibutylthiourea, tetramethylthiourea, and ethylenethiourea. Examples of the transition metal salt include cobalt naphthenate, copper naphthenate, and vanadyl acetylacetonate. Regarding the reducing agent, one kind thereof can be used alone, or two or more kinds thereof can be used in combination.

From the viewpoint of having an excellent curing rate, the reducing agent is preferably a thiourea derivative or a transition metal salt. The thiourea derivative may be, for example, ethylenethiourea. From the same viewpoint, the transition metal salt is preferably vanadyl acetylacetonate.

The content of the reducing agent may be 0.05% by mass or more, 0.1% by mass or more, or 0.3% by mass or more, and may be 5% by mass or less, 3% by mass or less, or 1% by mass or less, based on the total amount of the liquids constituting the composition set.

The composition set may further contain additives. The additives may be contained in either or both of the first liquid and the second liquid or may be contained in a third liquid different from the first liquid and the second liquid. The content of the additives based on the total amount of the liquids constituting the composition set may be the same as the range of the content of the additives based on the total amount of the above-mentioned composition.

[Sheet]

A sheet according to an embodiment contains first hollow particles, which are thermally expandable hollow particles; second hollow particles, which are hollow particles other than the first hollow particles; and a matrix polymer.

The types and contents of the first and second hollow particles contained in the sheet may be the same as those of the first and second hollow particles contained in the above-described composition or composition set. It should be noted that “based on the total mass of the composition” is read as “based on the total mass of the sheet”, and “based on the total volume of the composition” is read as “based on the total volume of the sheet”.

The matrix polymer contained in the sheet is a polymer (binder polymer) serving as a base material (forming a continuous phase) for holding other materials contained in the sheet. The matrix polymer is a polymer of the polymerizable compound contained in the above-described composition or composition set.

The content of the matrix polymer may be, for example, 40% by mass or more, 50% by mass or more, 60% by mass or more, or 70% by mass or more, and may be 95% by mass or less, or 90% by mass or less, based on the total mass of the sheet.

The thickness of the sheet is not particularly limited, and the thickness may be, for example, 200 μm or more and may be 2000 μm or less.

The sheet may further contain the additives which can be contained in the composition or the composition set described above. In this case, the content of the additives contained in the sheet may be the same as the content of the additives contained in the composition or the composition set described above (the terms for the content are replaced in the same manner as described above).

The sheet according to the present embodiment is obtained by, for example, carrying out polymerization of the polymerizable components in the above-mentioned composition or composition set and curing the composition or the composition set. That is, the sheet of the present embodiment can also be described as a sheet of a polymerized product (cured product) of the above-mentioned composition or the composition set.

### Examples

Hereinafter, the present invention will be described more specifically based on Examples; however, the present invention is not intended to be limited to these Examples.

In the Examples and Comparative Examples, each of the following components was used.

(First Hollow Particles)
A-1: “MATSUMOTO MICROSPHERE (registered trademark) F-190SSD” manufactured by Matsumoto Yushi-Seiyaku Co., Ltd., (average particle size: 10 to 15 μm, maximum volumetric expansion ratio: 50 times or more, expansion initiation temperature: 155° C. to 165° C., maximum expansion temperature: 210° C. to 220° C.)
A-2: “MATSUMOTO MICROSPHERE (registered trademark) F-190D” manufactured by Matsumoto Yushi-Seiyaku Co., Ltd. (average particle size: 30 to 40 μm, maximum volumetric expansion ratio: 50 times or more, expansion initiation temperature: 160° C. to 170° C., maximum expansion temperature: 210° C. to 220° C.)
A-3: “D-210D” manufactured by Matsumoto Yushi-Seiyaku Co., Ltd. (average particle size: 35 to 40 μm, maximum volumetric expansion ratio: 50 times or more, expansion initiation temperature: 200° C. to 210° C., maximum expansion temperature: 220° C. to 230° C.)
A-4: “MATSUMOTO MICROSPHERE (registered trademark) F-230D” manufactured by Matsumoto Yushi-Seiyaku Co., Ltd. (average particle size: 20 to 35 μm, maximum volumetric expansion ratio: 50 times or more, expansion initiation temperature: 180° C. to 190° C., maximum expansion temperature: 220° C. to 240° C.)
A-5: “MATSUMOTO MICROSPHERE (registered trademark) F-260D” manufactured by Matsumoto Yushi-Seiyaku Co., Ltd. (average particle size: 20 to 35 μm, maximum volumetric expansion ratio: 50 times or more, expansion initiation temperature: 190° C. to 200° C., maximum expansion temperature: 250° C. to 260° C.)

(Second Hollow Particles)
B: “Expancel (registered trademark) 920 DE80d30” manufactured by Japan Fillite Co., Ltd. (average particle size 60 to 90 μm, density 30±3 kg/m′, maximum volumetric expansion ratio: less than 5 times)

(Polymerizable Compound)
C-1: Compound represented by the following Formula (1-5) synthesized by the procedure described below (weight average molecular weight: 15000, a mixture in which m1+m2 in the Formula (1-5) represents an integer of approximately 252±5, n1+n2 represents an integer of approximately 63±5 (provided that m1, m2, n1, and n2 are each an integer of 2 or greater, m1+n1≥100, and m2+n2≥100), viscosity at 25° C.: 50 Pa·s)

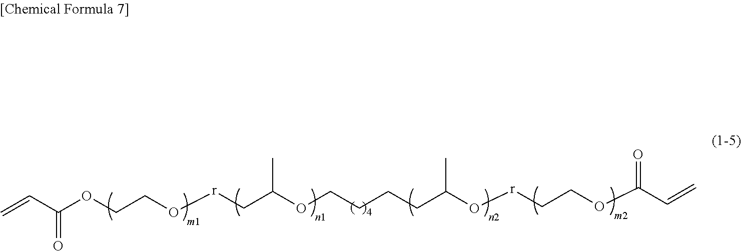

[in the Formula (1-5), -r- is a symbol representing random copolymerization.]
C-2: Dicyclopentanyl acrylate (“FANCRYL (registered trademark) FA-513A” manufactured by Showa Denko Materials Co., Ltd.)
C-3: 4-Hydroxybutyl acrylate (manufactured by OSAKA ORGANIC CHEMICAL INDUSTRY LTD.)

(Other Components)
D: Polymerization initiator (“PERBUTYL (registered trademark) 0” manufactured by NOF CORPORATION)
E: Phenol-based antioxidant (“ADEKA STAB (registered trademark) AO-80” manufactured by ADEKA Corporation)
F: Surface adjusting agent (“BYK (registered trademark) 350” manufactured by BYK Chemie GmbH)

[Synthesis of Compound Represented by Formula (1-5)]

A 500-mL flask equipped with a stirrer, a thermometer, a nitrogen gas inlet tube, a discharge tube, and a heating jacket was used as a reactor, 225 g of a glycol having a polyoxyalkylene chain (“NEWPOL 75H-90000” manufactured by Sanyo Chemical Industries, Ltd.) and 300 g of toluene were introduced into the reactor, the mixture was stirred at 45° C. and a speed of stirring rotation of 250 times/min, nitrogen was allowed to flow at a rate of 100 mL/min, and the mixture was stirred for 30 minutes. Subsequently, the temperature was lowered to 25° C., and after completion of the temperature lowering, 2.9 g of acryloyl chloride was added dropwise into the reactor, followed by stirring for 30 minutes. Subsequently, 3.8 g of triethylamine was added dropwise, and the mixture was stirred for 2 hours. Subsequently, the temperature was raised to 45° C., and the mixture was allowed to react for 2 hours. The reaction liquid was filtered, the filtrate was desolvated, and a compound represented by the Formula (1-5) was obtained.

[Production of Composition and Sheet]

Each of the components was mixed at the blending ratio indicated in Table 1, and a composition was obtained. Next, two sheets of substrates were prepared by placing a mold release-treated PET sheet (“A31” manufactured by TOYOBO CO., LTD.) on a glass plate, with the mold release-treated surface facing upward. A formwork made of silicone rubber and having a size of 10 cm×15 cm×1.0 mm was installed on the PET sheet of one of the substrates, and the inner side of the formwork was filled with the composition. In addition, the other substrate was used as an upper lid by placing the mold release-treated surface of the PET sheet of the other substrate on the composition side, and then the composition was cured by heating for minutes under the conditions of 135° C. As a result, sheets (thickness 1.0 mm) of cured products of the compositions according to Examples 1 to 10 and Comparative Example 1 were obtained.

[Measurement of Thermal Conductivity]

A produced sheet was cut into a size of 8 cm×13 cm×1.0 mm in a state of being sandwiched between the PET sheets, this cut piece was sandwiched between a reference plate and a measurement probe, and the thermal conductivity was measured with a rapid thermal conductivity meter (“QTM-710” manufactured by Kyoto Electronics Manufacturing Co., Ltd., measurement probe PD-11N, thin film measurement mode) under the conditions of 25° C. The reference was measured by stacking two sheets of mold release-treated PET (“A31” manufactured by TOYOBO CO., LTD.) and sandwiching the sheets between a reference plate and a measurement probe.

[Measurement of Adhesive Strength]

The produced sheet was stuck to a slide glass plate and left to stand for 15 minutes or more, and then three kinds of samples:
[1] in an unheated state at room temperature (20° C. to 25° C.),
[2] in a state of being heated at 220° C. for 120 seconds and then cooled to room temperature, and
[3] in a state of being heated at 260° C. for 30 seconds and then cooled to room temperature, were prepared. For each of these samples, the adhesive strength was measured by using “EZ Test EZ-S” manufactured by SHIMADZU CORPORATION (90° peeling, tensile rate: 50 mm/min).

For the sheets of Examples 1 to 10 and Comparative Example 1, the results for measuring each of the physical properties are shown in Table 1. Incidentally, in Table 1, the indication of the adhesive strength being “≥200” (N/m) implies that when it was attempted to peel off the sheet, the sheet underwent cohesive failure and could not be peeled off.

TABLE 1

| | | | | | | | | | | | | Compar- |
|---|---|---|---|---|---|---|---|---|---|---|---|---|
| | | Ex- | Ex- | Ex- | Ex- | Ex- | Ex- | Ex- | Ex- | Ex- | Ex- | ative |
| | | ample | ample | ample | ample | ample | ample | ample | ample | ample | ample | Ex- |
| | | 1 | 2 | 3 | 4 | 5 | 6 | 7 | 8 | 9 | 10 | ample 1 |
| Blending | A-1 | 8.5 | 11.0 | 13.4 | — | — | — | — | — | — | — | — |
| ratio | A-2 | — | — | — | 3.0 | 8.5 | 11.0 | 13.4 | — | — | — | — |
| (parts by | A-3 | — | — | — | — | — | — | — | 13.4 | — | — | — |
| mass) | A-4 | — | — | — | — | — | — | — | — | 13.4 | — | — |
| | A-5 | — | — | — | — | — | — | — | — | — | 13.4 | — |
| | B | 5.9 | 5.8 | 5.6 | 6.3 | 5.9 | 5.8 | 5.6 | 5.6 | 5.6 | 5.6 | 6.5 |
| | C-1 | 40.3 | 39.2 | 38.1 | 42.7 | 40.3 | 39.2 | 38.1 | 38.1 | 38.1 | 38.1 | 44.0 |
| | C-2 | 24.2 | 23.5 | 22.9 | 25.6 | 24.2 | 23.5 | 22.9 | 22.9 | 22.9 | 22.9 | 26.4 |
| | C-3 | 16.1 | 15.7 | 15.2 | 17.1 | 16.1 | 15.7 | 15.2 | 15.2 | 15.2 | 15.2 | 17.6 |
| | D | 1.0 | 0.9 | 0.9 | 1.0 | 1.0 | 0.9 | 0.9 | 0.9 | 0.9 | 0.9 | 1.1 |
| | E | 3.2 | 3.1 | 3.0 | 3.4 | 3.2 | 3.1 | 3.0 | 3.0 | 3.0 | 3.0 | 3.5 |
| | F | 0.8 | 0.8 | 0.8 | 0.9 | 0.8 | 0.8 | 0.8 | 0.8 | 0.8 | 0.8 | 0.9 |
| Blending amount of first | | 2.9 | 3.8 | 4.8 | 1.0 | 2.9 | 3.8 | 4.8 | 4.8 | 4.8 | 4.8 | — |
| hollow particles (% by volume) | | | | | | | | | | | | |
| Blending amount of second | | 67.9 | 67.3 | 66.6 | 69.3 | 67.9 | 67.3 | 66.6 | 66.6 | 66.6 | 66.6 | 70.0 |
| hollow particles (% by volume) | | | | | | | | | | | | |
| Blending amount of hollow | | 70.8 | 71.1 | 71.4 | 70.3 | 70.8 | 71.1 | 71.4 | 71.4 | 71.4 | 71.4 | 70.0 |
| particles (% by volume) | | | | | | | | | | | | |
| Thermal conductivity | | 66 | 66 | 66 | 62 | 64 | 65 | 63 | 66 | 63 | 66 | 66 |
| (mW/(m · K)) | | | | | | | | | | | | |
| Adhesive | Room | 30 | 29 | 33 | 30 | 29 | 26 | 26 | 31 | 30 | 30 | 30 |
| strength | temperature | | | | | | | | | | | |
| (N/m) | 220° C. | ≥200 | ≥200 | ≥200 | ≥200 | ≥200 | ≥200 | ≥200 | ≥200 | ≥200 | ≥200 | ≥200 |
| | 120 seconds | | | | | | | | | | | |
| | 260° C. | 64 | 12 | 7 | 31 | 22 | 0 | 3 | 70 | 96 | 96 | ≥200 |
| | 30 seconds | | | | | | | | | | | |

As described above, with regard to the sheets of Examples 1 to 10, it was found that since the adhesive strength in [2] a state of being heated at 220° C. for 120 seconds and then cooled to room temperature was large, the sheets can suitably adhere to devices during a reflow step, and since the adhesive strength in [3] a state of being heated at 260° C. for 30 seconds and then cooled to room temperature was small, the sheets can be easily removed after the reflow step.

1. A composition comprising:
first hollow particles being thermally expandable hollow particles;
second hollow particles being hollow particles other than the first hollow particles; and
a polymerizable compound.

2. The composition according to claim 1, wherein the first hollow particles have an expansion initiation temperature of 70° C. or higher.

3. The composition according to claim 1, wherein the first hollow particles have an expansion initiation temperature of 260° C. or lower.

4. The composition according to claim 1, wherein the first hollow particles have a maximum expansion temperature of 100° C. or higher.

5. The composition according to claim 1, wherein the first hollow particles have a maximum expansion temperature of 290° C. or lower.

6. A sheet comprising:
first hollow particles being thermally expandable hollow particles;
second hollow particles being hollow particles other than the first hollow particles; and
a matrix polymer.

7. The sheet according to claim 6, wherein the first hollow particles have an expansion initiation temperature of 70° C. or higher.

8. The sheet according to claim 6, wherein the first hollow particles have an expansion initiation temperature of 260° C. or lower.

9. The sheet according to claim 6, wherein the first hollow particles have a maximum expansion temperature of 100° C. or higher.

10. The sheet according to claim 6, wherein the first hollow particles have a maximum expansion temperature of 290° C. or lower.
